(19) United States
(12) Patent Application Publication
(10) Pub. No.: US 2004/0240535 A1
(43) Pub. Date: Dec. 2, 2004

(54) Fast exchange during intialization in multicarrier communication systems

(76) Inventors: Amit Verma, Mumbai (IN); M.T. Arvind, Bangalore (IN); Kiran Sreedharan, Bangalore (IN)

Correspondence Address: WELSH & KATZ, LTD, 120 S RIVERSIDE PLAZA, 22ND FLOOR, CHICAGO, IL, 60606, US

(21) Appl. No.: 10/477,250

(22) PCT Filed: May 10, 2002
(86) PCT No.: PCT/US02/14958

Related U.S. Application Data
(60) Provisional application No. 60/289,999, filed on May 10, 2001.
(60) Provisional application No. 60/307,954, filed on Jul. 26, 2001.

(51) Int. Cl. H04B 1/38

(52) U.S. Cl. 375/222

(57) ABSTRACT

Disclosed is a method for initializing multicarrier modems communicating over communication channels. The communication channels have a first plurality of subcarriers. The method includes measuring a signal-to-noise ratio for each subcarrier of the first plurality of subcarriers to determine whether the subcarrier is robust. It also includes sending an initialization message to a receiving multicarrier modem to indicate a second plurality of subcarriers which are robust and using the second plurality of subcarriers to send information from the receiving multicarrier modem.

### RELATED APPLICATIONS

This patent application claims the benefit of the filing date of U.S. Provisional patent application Ser. No. 60/289,999 filed May 10, 2001 entitled METHODS FOR FAST EXCHANGE DURING INITIALIZATION IN MULTICARRIER COMMUNICATION SYSTEMS and of U.S. Provisional patent application Ser. No. 60/307,954 filed Jul. 26, 2001 entitled METHODS FOR MITIGATION OF RESIDUAL INTER SYMBOL INTERFERENCE EFFECTS IN MULTICARRIER COMMUNICATION SYSTEMS. The contents of both applications are hereby incorporated by reference.

### FIELD OF THE INVENTION

This invention pertains to multicarrier data communication systems and more specifically to exchange of data transmission parameters during initialization of multicarrier modems.

### BACKGROUND

As is known, a multicarrier data communication system is one that employs Frequency Division Multiplexed (FDM) subchannels (commonly termed “subcarriers”) for transmission of data across a communication channel. A comprehensive description of multicarrier data communication systems is given by John A. C. Bingham in “Multicarrier Modulation for Data Transmission: An idea whose time has come”, IEEE Communication Magazine, Vol. 28, No 5, pp. 5-14, May 1990. There are different types of multicarrier data communication systems and various modulation techniques for such systems. Multicarrier modulation techniques include Discrete Multi-Tone (DMT) and Orthogonal Frequency Division Multicarrier (OFDM). A popular multicarrier data communication system employing DMT modulation is Asymmetric Digital Subscriber Line (ADSL).

A multicarrier data communication system typically includes a Central Office (CO) connected through a physical medium, called a channel, (e.g. copper cable, hybrid fiber, powerline, and wireless) to one or more Customer Premises Equipment (CPEs). Communication at each site is performed by multicarrier modems that perform receiving and transmitting of information. As per convention, the direction of communication from a CPE to the CO is known as upstream and the direction of communication from the CO to a CPE is known as downstream. In order to establish communication between a modem at a CPE (CPE modem) and a modem at a CO (CO modem), an initialization procedure is performed between the two modems. Whenever an existing communication fails or performance degrades due to changes in channel condition, a retrain procedure is performed. In comparison to the initialization procedure, the retrain procedure is typically of short duration and is meant to improve the performance of the communication whenever the channel conditions deviate from those in which initialization was performed. When the channel conditions change substantially, a complete initialization may be required to reestablish the communication.

A conventional initialization procedure involves the exchange of information necessary to configure the multicarrier modems for communication. This information is substantial and includes configuration parameters such as the number of bits and the power scaling for each subcarrier, and possibly a reordering the subcarriers to consider where the received bits are mapped on to the subcarriers. A conventional initialization procedure is specified by American National Standards Institute (ANSI T1.413) and entitled “Customer Interface-Asymmetric Digital Subscriber Line (ADSL) Metallic Interface” (August 1995) which is hereby incorporated by reference. Such a conventional procedure involves encoding information on a predesignated set of four contiguous subcarriers and modulating the information on to each subcarrier using simple Quadrature Amplitude Modulation (QAM). Modulating the information in such a conventional procedure does not take into consideration the sequence of bits being modulated which often causes a contiguous sequence of zeroes to be transmitted. A conventional procedure also limits the number of bits mapped to each frame to be a predesignated eight bits. Further, a conventional initialization procedure duplicates the information modulated on the first set of four contiguous subcarriers on to an alternate set of four contiguous subcarriers to improve the chances of success of the conventional initialization procedure.

The conventional initialization procedure has severe drawbacks. First, because the subcarriers are predesignated, the modems cannot choose other subcarriers if the predesignated subcarriers are not suitable for communication. The multicarrier modems may become unsuitable for communication if a measured SNR of the predesignated subcarriers falls below a reliable threshold. For example, SNR is impaired by “tonal” disturbers and/or “crosstalk” noise which normally occur in ADSL and other multicarrier data communication systems.

Second, since the amount of information needed to be sent during the initialization procedure is substantial and only eight bits of data are mapped to each frame, the amount of time to complete the initialization procedure is considerable and may take up to 15 minutes. Further, in an ADSL system, where the number of subcarriers is typically much larger for the downstream communication than the upstream communication, conveying the downstream multicarrier modem (e.g. CO modem) configuration takes much more time than the upstream multicarrier modem (e.g. CPE modem) configuration. Third, by allowing a continuous sequences of zeroes to be transmitted leads to lower reliability because of impairments such as incomplete equalization and increased peak transmit power. Further, other impairments due to incomplete equalization, such as residual Inter Symbol Interference (ISI) and peak power problems in the signal are also a problem in a conventional initialization procedure.

For all of these reasons, current initialization and/or retraining procedures suffer from many drawbacks and are limited. In order to improve the time and efficiency of the initialization procedure and the chances of success of initialization, it is necessary to improve the manner in which information is transmitted during initialization of the multicarrier modems. Accordingly, a need exists for methods for fast exchange during initialization in multicarrier communication systems.

### SUMMARY OF THE INVENTION

Under one embodiment of the invention, disclosed is a method for initializing multicarrier modems communicating over communication channels. The communication channels have a first plurality of subcarriers. The method includes measuring a signal-to-noise ratio for each subcarrier of the first plurality of subcarriers to determine whether the subcarrier is robust. It also includes sending an initialization message to a receiving multicarrier modem to indicate a second plurality of subcarriers which are robust and using the second plurality of subcarriers to send information from the receiving multicarrier modem.

Other embodiments, features and advantages of the invention will be apparent to one with skill in the art upon examination of the following figures and detailed description. It is intended that all such additional embodiments, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an initialization procedure according to one embodiment of the present invention.

FIG. 2 illustrates an example initialization message for a fixed number of subcarriers.

FIG. 3 illustrates an example initialization message for a variable number of subcarriers.

FIG. 4 illustrates an example initialization message for a variable number of subcarriers with a fixed number of bits determined by a transmitting modem to be encoded on each subcarrier.

FIG. 5 illustrates an example initialization message for a variable number of subcarriers with a variable number of bits encoded on each subcarrier.

FIG. 6 illustrates an embodiment for limiting the number of subcarriers.

### DETAILED DESCRIPTION

An exemplary embodiment of a multicarrier communication system includes a Central Office (CO) connected through a physical medium to one or more Customer Premises Equipment (CPEs). Located at both the CO and the CPEs are multicarrier modems that are responsible for the communication of information between the CO and the CPEs. In an exemplary embodiment of the present invention, the multicarrier modems support Asymmetrical Digital Subscriber Loop (ADSL) technology and communicate through twisted pair copper wires. The present invention is suitable for other embodiments of multicarrier communication systems and the mention of ADSL and copper wires is not meant to be limiting on the scope of the invention. For example, other suitable multicarrier systems include CDMA-OF and VOD. In addition, other suitable physical mediums include fiber optic cable, powerline, Radio Frequency (RF) wireless, and hybrid fiber cables. In any case, the multicarrier system requires that the physical medium support a communications channel of subcarrier frequencies, also termed “subcarriers.” Although ADSL is used to describe an embodiment of the present invention, the present invention can be implemented on any multicarrier data communication system characterized by a multicarrier communications channel having subcarriers for communication, including but not limited to ADSL.

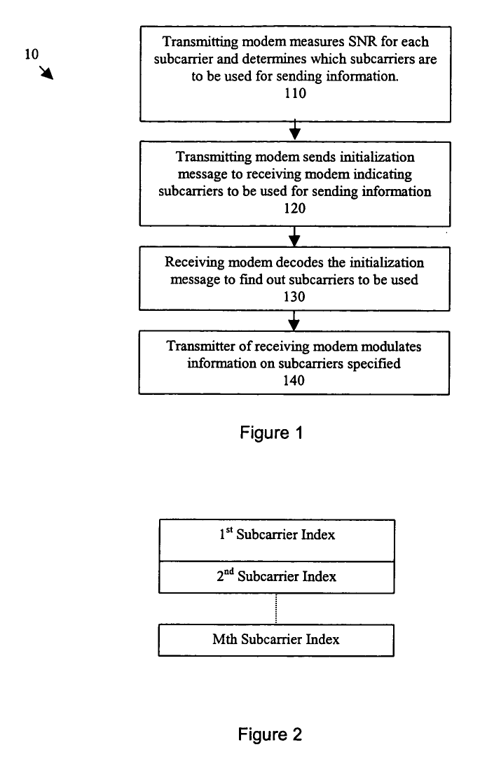

Before communication between the multicarrier modems may occur, an initialization procedure may be performed. An exemplary embodiment of an initialization procedure 10 according to the present invention is illustrated in FIG. 1. In an exemplary embodiment of the present invention, the initialization procedure 10 functions to establish communication between a modem at the CO (CO modem) and a modem at the CPE (CPE modem) by the exchange of necessary information to configure both the CO modem and the CPE modem for multicarrier communication. In an exemplary embodiment of the initialization procedure 10, the first phase of initialization functions to determine the presence of a compatible device and to establish a suitable connection between the CPE modem and the CO modem. For example, either the CPE modem or the CO modem initiates a connection by transmitting a predetermined set of tones or discrete frequencies to the other modem. The CO modem may detect the CPE modem's sent tones and the CO modem may send another set of tones to the CPE modem. This phase of initialization is referred to as “activation or handshake.”

The second phase of initialization, referred to as “transceiver training,” involves adjustment of transmit power levels, synchronization of clocks, and training of equalizers and echo cancellers in the CO modem and the CPE modem. The third phase of initialization, referred to as “channel analysis,” requires further training of equalizers and echo cancellers and a determination of Signal to Noise Ratios (SNRs) for each of the subcarriers of the communication channel as shown in Block 110 of FIG. 1. The determined SNR levels for each subcarrier are placed in a table and used by the modem to determine robust subcarriers. A subcarrier is considered to be “robust” where it meets a threshold value determined by the modem's consideration of parameters including the bit error rate. For example, in an exemplary embodiment of the present invention, high SNRs having a bit error rate of 10⁷ may be considered to be “robust” subcarriers. Further, data rates for each subcarrier may be calculated by using the determined SNR for the subcarrier. It is important to note that each modem performs measurements of SNR for each subcarrier. Thus, data rates for upstream and downstream communication may be different because the measured SNRs may be different.

Using the results of the channel analysis phase, the last phase of initialization, referred to as “exchange or rate negotiation,” functions to indicate the parameters for further communication that will take place during the rest of the initialization procedure 10 (block 120). In general, during this phase, the CO modem may indicate a fixed number of possible transmitter configurations whereby the CPE modem may either choose one of the sent transmitter configurations or send information to help the CO modem arrive at different choices for the downstream transmitter configuration. Also, the CO modem may send the upstream configuration to the CPE modem. The CO modem may convey the new downstream choices to the CPE modem. In an exemplary embodiment of the present invention, the CPE modem must select one of these new downstream choices for communication to continue. In an exemplary embodiment, once the upstream and downstream configurations are finalized and transmitter configurations are exchanged, the initialization procedure 10 is complete.

In an embodiment of the present invention, indicating the parameters for further communication requires that an initialization message be sent between the CO modem and the CPE modem (block 120). The initialization message functions to send information regarding the subcarriers to be used by the transmitter of the modem sending the initialization message. The initialization message may also indicate the number of bits that should be modulated on each subcarrier. Further, the initialization message should be transmitted using a robust signaling mechanism so that it can be reliably detected and decoded. The format of this initialization message is prespecified and known to the remote modem. In many situations, the initialization message length may be fixed. Typically, this initialization message uses a wide band signal with one bit per DMT frame encoding. If a particular wide band signal is used to indicate a ‘1’ bit, the phase-reversed version of the same signal could be used to indicate a ‘0’ bit. Alternatively, the ‘1’ and ‘0’ bits may be conveyed by the presence and absence of a wideband signal.

The receiving modem may receive the initialization message and may decode the initialization message to determine the subcarriers, the number of bits to be modulated on each subcarrier, and other relevant parameters to be used for the rest of the initialization procedure 10 (block 130). The receiving modem may then send information on the subcarriers specified by the initialization message (block 140). For example, the initialization message may indicate that information bits are mapped to a QAM constellation of 4 bits and that the resulting symbol be modulated on a subcarrier having a frequency of X. In an alternate embodiment, a data connection may be established to communicate the rest of the initialization procedure 10 and specifically the rest of the “exchange and rate negotiation” phase. If a data connection is established, then the initialization procedure 10 may be communicated along with data for the data connection.

In one embodiment of the present invention, the initialization message indicates that the modem may operate with a fixed number of subcarriers that are determined by the modem transmitting (“transmitting modem”) the initialization message (block 120). A receiver of the transmitting modem selects the subcarriers to be used for modulating information based upon the measured SNRs of each subcarrier found during the channel analysis phase of the initialization procedure 10. In an exemplary embodiment, the number of subcarriers is fixed at four subcarriers, although the receiver of the transmitting modem can determine any suitable number of subcarriers. In any case, the number of subcarriers is predetermined and known to the modem receiving (“receiving modem”) the initialization message. Even though the number of subcarriers is predetermined, the receiver of the transmitting modem determines the frequencies of the subcarriers. This procedure allows the receiver of the transmitting modem the flexibility to choose subcarriers with “robust” SNRs that may be more efficient for carrying out the initialization procedure 10.

In an exemplary embodiment of an initialization message where the message indicates a fixed number of subcarriers, the initialization message may indicate the “robust” subcarriers to the receiving modem by communicating an index of the subcarriers. For example, where the number of subcarriers is required to be contiguous, only the beginning subcarrier index needs to be conveyed. The subcarrier index may be encoded in a binary format and communicated using a wide band signal encoding method. Shown in FIG. 2 is an example format for the initialization message to indicate the fixed number of subcarriers determined by the receiver of the transmitting modem. For example, if there is a number N subcarriers and a number M determined “robust” subcarriers, then the minimum number of bits b of the initialization message to indicate the receiver chosen fixed subcarriers is

b=number of the second plurality of subcarriers*┌log₂(number of the first plurality of subcarriers)┐

If M “robust” subcarriers out of N total subcarriers are chosen by the receiver of the transmitting modem, the initialization message will have at a minimum M*b bits. For example, if N=31 and M=4, b=5 and the initialization message length is at least 20 bits. In an exemplary embodiment of the present invention, the initialization message may also include other bits for error detection and may also include other bits for error correction. Thus, in the above example, the initialization message may include another 8 bits for error detection and error correction.

In another embodiment of the present invention, the initialization message indicates that the transmitting modem may operate with a variable number of subcarriers that are determined by the modem transmitting the initialization message (block 120). A receiver of the transmitting modem selects the subcarriers to be used for modulating information based upon the measured SNRs of each subcarrier found during the channel analysis phase of the initialization procedure 10. The receiver of the transmitting modem determines which subcarriers are “robust” and suitable for communication. In an exemplary embodiment, the number of subcarriers is variable with a range of 256 subcarriers. The receiving modem knows a prior that the modem will be transmitting an initialization message indicating a variable number of subcarriers with “robust” SNRs. This procedure allows the receiver of the transmitting modem the flexibility to choose subcarriers with “robust” SNRs that may be more efficient for carrying out the initialization procedure 10.

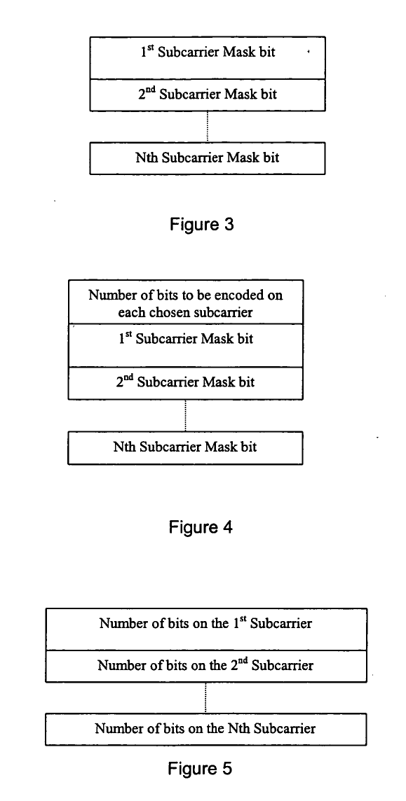

In an exemplary embodiment of an initialization message where the message indicates a variable number of subcarriers, the initialization message may indicate the “robust” subcarriers to the receiving modem by communicating a mask. For example, the mask may include as many bits as the number of subcarriers where each bit denotes whether the subcarrier is “robust” or not. In such an example, a “1” bit may be used to indicate that the subcarrier is “robust” and to be used, whereas a “0” bit may be used to indicate that the subcarrier is not “robust” and is not to be used. FIG. 3 illustrates an exemplary initialization message for indicating a variable number of subcarriers where the multicarrier data communication system employs N number of subcarriers and a N-bit mask is used to indicate the “robust” subcarriers. In an exemplary embodiment of the present invention, the initialization message may also include other bits for error detection and may also include other bits for error correction. Thus, in the above example, the initialization message may include another 8 bits for error detection and error correction.

In either of the above embodiments whether the embodiment with fixed number of subcarriers or the embodiment with a variable number of subcarriers, the receiver of the transmitting modem may determine whether to map the same number of bits to each “robust” subcarrier or to map a variable number of bits to each “robust” subcarrier (block 120). When channel conditions are good and favorable for communication, having the receiver of the transmitting modem determine the number of bits to be mapped on each subcarrier may further reduce the duration of the initialization procedure 10.

In yet another embodiment, the receiver of the transmitting modem may determine to encode the same number of bits onto each of the subcarriers where the number of bits is also determined by the receiver of the transmitting modem (block 120). FIG. 4 illustrates an example initialization message where the number of bits to be encoded on each determined “robust” carrier is fixed and indicated in the message. Illustrated in FIG. 4 there is N number of subcarriers so the initialization message can be encoded as an N bit mask. Additionally, if the maximum number of bits that any subcarrier can carry is encoded in ‘b’ bits, a ‘b’ bit field is added at the start of the initialization message. Further, the initialization message may include additional bits for error detection and error correction.

In yet another embodiment, the receiver of the transmitting modem may determine to encode a variable number of bits onto each of the subcarriers (block 120). The receiver of the transmitting modem may use the initialization message as illustrated in FIG. 5. Illustrated is a subcarrier field for each subcarrier where the field is more than one bit. For example, if the maximum number of its that a subcarrier can carry is 15, then the subcarrier field is of 4 bits length. Moreover, the encoding 0 may be used to indicate that the subcarrier is not to be used. Illustrated in FIG. 5 there are N number of subcarriers so the initialization message can be encoded as an N*the maximum number of bits to encode the subcarrier) bit mask. As illustrated in FIG. 5, if there are N subcarriers and the maximum number of bits carried by any subcarrier can be encoded in ‘b’ bits, the initialization message is at least N*b bits long. The initialization message may include N blocks of ‘b’ bits each, where the ‘m’th ‘b’ bit block indicates the number of bits to be carried by the ‘m’th subcarrier. Further, the initialization message may include additional bits for error detection and error correction.

Whether the number of bits is fixed or variable, the initialization message may include a field for indicating whether each subcarrier is used indicating whether the subcarrier is “robust” or not (block 120). Further, determining whether to keep the number of bits fixed or variable is a decision made a priori. If the receiver of the transmitting modem determines the number of bits to be encoded onto each subcarrier then the length of the initialization message may increase but the tradeoff may be worth the savings found in the duration of the initialization procedure 10.

In yet another embodiment, the receiver of the transmitting modem utilizes a technique termed “frequency diversity” to improve the robustness of the initialization procedure 10 (block 120). The technique of frequency diversity requires that the receiver of the transmitting modem duplicate the same information on different subcarriers. For a frequency diversity factor of “f,” the receiver of the transmitting modem may choose an integral multiple of “f” (e.g. “M”) to encode either a variable number of bits or a fixed number of bits onto each subcarrier. For example for a frequency diversity factor of 3, transmitted information is copied to six different subcarriers. Further, the frequency diversity factor ‘f’ may be either fixed a priori or determined by the receiver of the transmitting modem. In the latter case, the value of ‘f’ may be specified by the initialization message. Further, frequency diversity may be used with any of the above embodiments. For example, frequency diversity may be combined with the embodiment where the number of subcarriers is fixed and the number of bits encoded on each subcarrier is fixed, where the number of subcarriers is fixed and the number of bits encoded on each subcarrier is variable, where the number of subcarriers is variable and the number of bits encoded on each subcarrier is fixed, and where the number of subcarriers is variable and the number of bits encoded on each subcarrier is variable. Further each of the above embodiments may employ a predetermined frequency diversity factor or require that the receiver of the transmitting modem determine the frequency factor. Even with frequency diversity, the initialization message may include additional bits for error detection and error correction.

In yet another embodiment, the receiver of the transmitting modem utilizes a technique termed “randomization” to improve the robustness of the initialization procedure 10 (block 120). Problems that degrade the channel include filter roll-off, time-domain aliasing, and not using subcarriers. Further, when initialization messages contain a continuous pattern, e.g. a continuous sequence of zeroes, the SNR of the subcarrier carrying the initialization message may degrade. Modulating a continuous sequence of 0s onto a set of subcarriers may result in a time domain signal at the IFFT modulator output that has a high peak power. Generation of peaks at the IFFT output has a detrimental effect. Such a (unrandomized) sequence may result in more energy in the time-domain samples towards the end of the DMT symbol boundary. This may cause a greater amount of Inter Symbol Interference (ISI) to the DMT symbol immediately following it. If the sequence is unrandomized, the error as a result of the ISI may result in reduced subcarrier SNR at the receiver end.

The high peak power as a result of modulating a repetitive bit pattern may additionally cause clipping to occur at the transmitter. Since the average transmit power is fixed, one or more of the peak samples fed to the Digital to Analog Converter (DAC) could be clipped. This could potentially result in an erroneous signal being transmitted and therefore incorrectly received at the receiver end.

Randomization is proposed by this invention as a means to mitigate the effects of residual ISI at the output of the equalizer at the receiver as also reducing the peak power at the transmitter. The embodiments proposed describe specific randomization schemes with varying degrees of computational complexity to help improve the robustness of the initialization procedure 10.

Randomization may be performed on symbols at an output of a constellation encoder of the transmitting modem. This is achieved by multiplying the output of the constellation encoder by a prespecified complex pseudo-random phase sequence. The amplitude of each point in this sequence is identical and can be considered to be unity. Hence the point-by-point multiplication using the normalized pseudo random sequence preserves the power level of each subcarrier after multiplication. At the receiver of the receiving modem, a constellation decoder of the receiving modem may be multiplied point-by-point by the complex conjugate of the normalized pseudo random sequence to recover back the original constellation points. This scheme may result in reduced peak power of the transmit signal in addition to improved ISI mitigation at the receiver.

Randomization may also be performed by multiplying point-by-point the output of the constellation encoder with the real part of the complex point for all subcarriers by a prespecified pseudo random sequence taking values from {1, −1}. Similarly the imaginary part of the constellation encoder output is multiplied point-by-point by a similar (prespecified) pseudo random sequence. At the receiver end a similar multiplication as in the transmit side recovers back the original information. This scheme too results in reduced peak power of the transmit signal and improved residual ISI mitigation at the receiver with the added benefit of reduced computational complexity.

Randomization may also be performed on the input bit-sequence prior to the constellation encoder. This may be achieved by using a scrambler polynomial. When the initial state of the scrambler is all 0s, the output of the scrambler may still be a sequence of 0s in case the input sequence starts with a sequence of 0s. For this reason, the initial state of the scrambler needs to be set to a non-zero value in order to get a randomized sequence at the output for any input sequence. For certain scramblers, the initial state needs to be set to all 1s. By using this method, any repetitive bit-sequence in the input data is changed to a random pattern of 0s and is which when mapped on a set of subcarriers results in reduced peak power at the transmitter end and better ISI mitigation at the receiver.

In yet another embodiment, the receiver of the transmitting modem utilizes a technique termed “time domain signal manipulation” to improve the robustness of the initialization procedure 10 (block 120). Samples at an Inverse Fast Fourier Transformer (IFFT) output are cyclically shifted by a pre-specified number of samples before the addition of the cyclic prefix. Because the last few samples in a DMT symbol typically have much higher energy compared to the first few samples, these last few samples of a DMT symbol contribute to the ISI of the next sample; therefore, by reducing the energy in these last few samples may increase the robustness. The cyclic shifting is done in such a way that for a cyclic shift of 1 sample, the last sample is shifted out to occupy the first shift position after the remaining samples have been shifted right by 1 position.

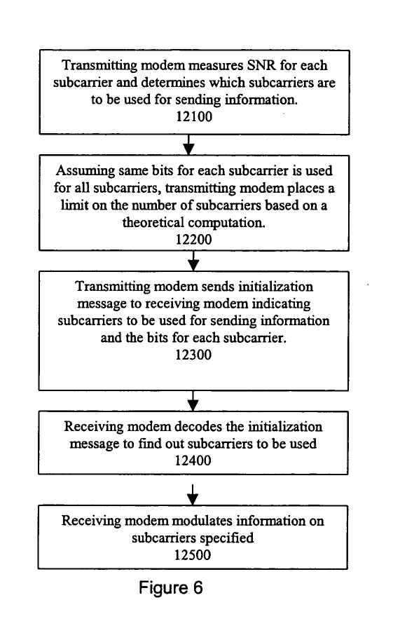

In yet another embodiment, the receiver of the transmitting modem limits the number of subcarriers to improve the robustness of the initialization procedure 10 (block 120). Peak power is limited by using only a subset of subcarriers chosen from the set of subcarriers that can be used to transmit the exchange information. Assuming that each subcarrier carries the same number of bits, the number of bits being predetermined, the power is reduced because the number of subcarriers is limited. Because the power is limited, the problem of clipping at the transmitter may be eliminated. A typical method for computing the maximum number of subcarriers with a fixed number of for each subcarrier is illustrated in FIG. 6 and is described below.

1) Given the bits for each subcarrier b which is same for all subcarriers, set number of subcarriers N equal to 1.

2) Compute the peak value of the time-domain signal assuming the farthest constellation point is chosen for each of the N subcarriers and assuming that peak values for N subcarriers add in phase.

i.e. Peak=(N)*(Peak value of constellation point assuming farthest point for chosen constellation)

3) Compute the (Root Mean Square) RMS value for the chosen constellation and for N subcarriers and let it be equal to RMS_{N}.

4) Compute amplitude_reduction equal to:

(Rms value of wideband pseudo random signal)/(RMS_{N})

5) Compute effective (Peak to Average Ratio) PAR equal to (Peak/RMS_{N})/amplitude_reduction and check if effective PAR is greater than dac_occupancy. The dac_occupancy is defined as the ratio of the DAC peak value to the rms value of the wideband pseudo random signal. If effective PAR greater then goto step 7) else goto step 6).

6) Increment the N by 1 and repeat steps 2-5 after checking that N does not exceed the limit imposed by bandwidth/sampling frequency etc.

7) The value N is the max number of subcarriers to be used for rate negotiation.

8) Repeat steps 1-7 using a different number of bits for each subcarrier.

Further, those skilled in the art will realize that the above method is also applicable to an embodiment where the number of bits per subcarrier is variable but subject to a limit of b number of bits. Further, similar procedures with varying degrees of complexity can also be derived for determining the number of subcarriers. In addition, combining the embodiment where randomization is used by the transmitting modem with the embodiment where the number of subcarriers is limited may achieve greater ISI mitigation and greater peak power reduction than utilizing either one of the embodiments alone. In addition, combining the embodiment where time domain signal manipulation is used by the transmitting modem with the embodiment where the number of subcarriers is limited may achieve greater ISI mitigation and greater peak power reduction than utilizing either one of the embodiments alone. Further, robustness to impulse noise can be achieved by employing forward error correction at the transmitter in conjunction with transmit data interleaving. For example, as is known in the art, Reed Solomon FEC could be employed in conjunction with a convolution ADSL interleaver with prespecified parameter settings.

Those skilled in the art will recognize that several generalizations of the invention are easily possible. It is easy to see that this mechanism can be employed in any multicarrier communication system to improve the speed and reliability of data transfer during the exchange or rate negotiation phase of initialization. It is also easy to see that the initialization message can be designed in several ways in order to exploit particular characteristics of the multicarrier communication system under consideration. Although the preferred embodiment addresses an ADSL system, the concepts easily generalize to other DSL and other multicarrier techniques like OFDM and Discrete Wavelet Multi-Tone (DWMT).

While various embodiments of the invention have been described, it will be apparent to those of ordinary skill in the art that many more embodiments and implementations are possible that are within the scope of this invention.

What is claimed is:

1. A method for initializing multicarrier modems communicating over communication channels having a first plurality of subcarriers, the method comprising the steps of:
measuring a signal-to-noise ratio for each subcarrier of the first plurality of subcarriers to determine whether the subcarrier is robust;
sending an initialization message to a receiving multicarrier modem indicating a second plurality of subcarriers comprising the robust subcarriers; and
using the second plurality of subcarriers to send information from the receiving multicarrier modem.

2. The method as in claim 1 wherein the step of sending further comprises the step of formatting the initialization message to comprise the procedure for modulating future communications occurring during the initializing.

3. The method as in claim 2 wherein the initialization message indicates that a number of the second plurality of subcarriers is a fixed number of subcarriers.

4. The method as in claim 3 wherein the minimum length in bits of the initialization message can be calculated by the following formula
number of the second plurality of subcarriers*┌log₂(number of the first plurality of subcarriers)┐

5. The method as in claim 3 wherein each subcarrier of the second plurality of subcarriers carry a same number of bits.

6. The method as in claim 5 wherein the same number of bits is determined by a transmitting modem at the time that an initialization message is being formatted.

7. The method as in claim 5 wherein the same number of bits is predesignated.

8. The method as in claim 3 wherein peak power is reduced by limiting the fixed number of subcarriers to a third plurality of subcarriers calculated by considering the same number of bits, a peak value assuming a constellation value, and a DAC peak value whereby the third plurality of subcarriers does not exceed a multicarrier system bandwidth.

9. The method as in claim 2 wherein the initialization message indicates that a number of the second plurality of subcarriers is a variable number of subcarriers.

10. The method as in claim 9 wherein a minimum length in bits of the initialization message is equal to a number of the first plurality of subcarriers.

11. The method as in claim 9 wherein each subcarrier of the second plurality of subcarriers carry a same number of bits.

12. The method as in claim 11 wherein the same number of bits is determined by transmitting modem at the time that an initialization message is being formatted.

13. The method as in claim 11 wherein the same number of bits is predesignated.

14. The method as in claim 9 wherein peak power is reduced by limiting the variable number of subcarriers to a third plurality of subcarriers calculated by considering the same number of bits, a peak value assuming a constellation value, and a DAC peak value whereby the third plurality of subcarriers does not exceed a multicarrier system bandwidth.

15. The method as in claim 9 wherein each subcarrier of the second plurality of subcarriers carry a different number of bits.

16. The method as in claim 9 wherein the initialization message indicates a number of bits to be carried on each subcarrier.

17. The method as in claim 2 wherein frequency diversity is implemented to duplicate communicated information to the remote multicarrier modem.

18. The method as in claim 17 wherein the frequency diversity factor is a variable number determined by a receiver of a multicarrier modem.

19. The method as in claim 1 further comprising the step of performing randomization on the communicated information to reduce the peak power of a multicarrier modem transmitting the communicated information.

20. The method as in claim 19 wherein the randomization is a symbol type and performed on symbols output from a constellation encoder of a multicarrier modem.

21. The method as in claim 19 wherein the randomization is a bit type and performed on bits input to a constellation encoder of a multicarrier modem.

22. The method as in claim 21 wherein the randomization is performed on the bits using a polynomial scrambler with an initial state set to a non-zero value.

23. The method as in claim 1 further comprising the step of performing time domain signal manipulation on the communicated information to move the peak power of a multicarrier modem transmitting the communicated information.

24. A multicarrier modem for communicating over communication channels having a first plurality of subcarriers, the modem comprising:
an evaluator which measures a signal-to-noise ratio for each subcarrier of the first plurality of subcarriers and determines whether the subcarrier is robust;
a communicator for sending an initialization message to a receiving multicarrier modem indicating a second plurality of subcarriers comprising the robust subcarriers; and
a receiver of the multicarrier modem which utilizes the second plurality of subcarriers to receive information from the receiving multicarrier modem.

25. The system as in claim 24 wherein the communicator further comprises a formatter for assembling the initialization message which indicates the procedure for modulating future communications.

26. The system as in claim 25 wherein the initialization message indicates that a number of the second plurality of subcarriers is a fixed number of subcarriers.

27. The system as in claim 26 wherein the minimum length in bits of the initialization message can be calculated by the following formula
number of the second plurality of subcarriers*┌log₂(number of the first plurality of subcarriers)┐

28. The system as in claim 26 wherein each subcarrier of the second plurality of subcarriers carry a same number of bits.

29. The system as in claim 28 wherein the same number of bits is determined by a transmitting modem at the time that an initialization message is being formatted.

30. The system as in claim 28 wherein the same number of bits is predesignated.

31. The system as in claim 26 wherein peak power is reduced by limiting the fixed number of subcarriers to a third plurality of subcarriers calculated by considering the same number of bits, a peak value assuming a constellation value, and a DAC peak value whereby the third plurality of subcarriers does not exceed a multicarrier system bandwidth.

32. The system as in claim 25 wherein the initialization message indicates that a number of the second plurality of subcarriers is a variable number of subcarriers.

33. The system as in claim 32 wherein the minimum length in bits of the initialization message is equal to a number of the first plurality of subcarriers.

34. The system as in claim 32 wherein each subcarrier of the second plurality of subcarriers carry a same number of bits.

35. The system as in claim 34 wherein the same number of bits is determined by transmitting modem at the time that an initialization message is being formatted.

36. The system as in claim 34 wherein the same number of bits is predesignated.

37. The system as in claim 32 wherein peak power is reduced by limiting the variable number of subcarriers to a third plurality of subcarriers calculated by considering the same number of bits, a peak value assuming a constellation value, and a DAC peak value whereby the third plurality of subcarriers does not exceed a multicarrier system bandwidth.

38. The system as in claim 32 wherein each subcarrier of the second plurality of subcarriers carry a different number of bits.

39. The system as in claim 32 wherein the initialization message indicates a number of bits to be carried on each subcarrier.

40. The system as in claim 25 wherein frequency diversity is implemented to duplicate communicated information to the remote multicarrier modem.

41. The system as in claim 40 wherein the frequency diversity factor is a variable number determined by a receiver of a multicarrier modem.

42. The system as in claim 24 further comprising the step of performing randomization on the communicated information to reduce the peak power of a multicarrier modem transmitting the communicated information.

43. The method as in claim 32 wherein the randomization is a symbol type and performed on symbols output from a constellation encoder of a multicarrier modem.

44. The system as in claim 32 wherein the randomization is a bit type and performed on bits input to a constellation encoder of a multicarrier modem.

45. The system as in claim 32 wherein the randomization is a bit type and performed on bits input to a constellation encoder of a multicarrier modem.

46. The system as in claim 45 wherein the randomization is performed on the bits using a polynomial scrambler with an initial state set to a non-zero value.

47. A system for initializing multicarrier modems for communicating over communication channels having a first plurality of subcarriers, the modem comprising:
means for measuring a signal-to-noise ratio for each subcarrier of the first plurality of subcarriers to determine whether the subcarrier is robust;
means for sending an initialization message to a receiving multicarrier modem indicating a second plurality of subcarriers comprising the robust subcarriers; and
means for using the second plurality of subcarriers to send information from the receiving multicarrier modem
